(19) United States
(12) Patent Application Publication
(10) Pub. No.: US 2024/0158313 A1
(43) Pub. Date: May 16, 2024

(54) ZINC OXIDE-BASED SUSTAINABLE NANOFERTILIZERS FOR ENHANCED CROP GROWTH

(71) Applicant: University of Dayton, Dayton, OH (US)

(72) Inventor: Soubantika Palchoudhury, Xenia, OH (US)

(21) Appl. No.: 18/506,852

(22) Filed: Nov. 10, 2023

Related U.S. Application Data
(60) Provisional application No. 63/424,722, filed on Nov. 11, 2022.

(51) Int. Cl. C05D 9/02; C05G 5/23; C05G 5/30

(52) U.S. Cl. CPC C05D 9/02; C05G 5/23; C05G 5/37

(57) ABSTRACT

The present disclosure provides materials and methods for sustainable enhancement of crop growth. More particularly, provided are nanofertilizers comprising zinc oxide and a biocompatible polymer, and methods of enhancing crop growth by application of such nanofertilizers to plant pre-germinational tissue prior to germination.

### CROSS-REFERENCE TO RELATED APPLICATIONS

This application claims the benefit under 35 U.S.C. § 119 of U.S. Provisional Application No. 63/424,722, filed Nov. 11, 2022, the contents of which are incorporated herein in their entirety.

### FIELD

The present disclosure relates to crop growth, and more particularly, to sustainable nanofertilizers for enhancement of crop growth.

### BACKGROUND

Current commercial agricultural production requires the use of bulk fertilizers in huge excess of each plant's biomolecular needs to enhance crop yield and meet the rapidly increasing global demand for food and bioenergy crops. Such bulk fertilizer use increases the cost of farming and present significant concerns for the environmental health of farms and their surrounding ecosystems. Accordingly, alternatives are needed to reduce overreliance on bulk fertilizer and improve crop yield efficiencies. The present disclosure addresses these long-felt unmet needs.

### SUMMARY

Crop growers all over the world face a challenge to increase agricultural output in response to rising global food and energy insecurity. The present disclosure provides compositions and methods for improving crop yields.

In an aspect, the present disclosure provides a nanofertilizer composition comprising a particle, the particle comprising a crystalline core comprising zinc oxide, a coating covering a surface area of the crystalline core, the coating comprising a biocompatible polymer. In any embodiment, the crystalline core may further comprise an oxide of copper and oxide of iron. In any embodiment, the crystalline core may comprise a mixture of cubic-phase Cu₄Zn₆Fe₂O₄ and trigonal hematite. In any embodiment, the relative molar amounts in the crystal of zinc, copper, and iron may be about 1:1:8.

In any embodiment of the nanofertilizer composition, the coating may be selected from: polyethylenimine, polyvinylpyrrolidone, and a mixture of polyethylenimine and polyvinylpyrrolidone.

In any embodiment, the zinc oxide of the crystalline core may comprise a crystal structure selected from: hexagonal, cubic, and a mixture of hexagonal and cubic.

In any embodiment, the particle may have hydrodynamic diameter of about 50 nm to about 175 nm. In any embodiment, the particle may have a diameter of about 5 nm to about 15 nm.

In another aspect, the present disclosure provides a fertilizer composition comprising an aqueous solution comprising the nanofertilizer composition described herein.

In still another aspect, the present disclosure provides a nanofertilizer particle comprising a crystalline core comprising a mixture of oxide of zinc, oxide of iron, and oxide of copper, and a coating covering a surface area of the crystalline core, the coating comprising a biocompatible polymer comprising polyethylenimine, polyvinylpyrrolidone, or a mixture of polyethylenimine and polyvinylpyrrolidone.

In a further aspect, the present disclosure provides a method of enhancing plant growth, the method comprising contacting a germination-capable plant tissue with an aqueous fertilizer for a period of time prior to germination of the germination-capable plant tissue, wherein the aqueous fertilizer comprises a solution comprising a nanofertilizer composition comprising a nanoparticle, the nanoparticle comprising a crystalline core comprising zinc oxide, and a coating covering a surface area of the crystalline core, the coating comprising a biocompatible polymer.

In any embodiment of the method, the germination-capable plant tissue may be a seed of maize. In any embodiment, the germination-capable plant tissue may be a seed of a legume. In any embodiment, the legume may be selected from: chickpea, green bean, green gram, and pea.

In any embodiment, the volume of the aqueous fertilizer contacted to the germination-capable plant tissue may be about 0.01 mL to 0.1 mL. In any embodiment, the mass of nanofertilizer composition in the volume of aqueous fertilizer may be about 0.1 mg to 3 mg. In any embodiment, the concentration of nanofertilizer composition in the solution may be 0.01 g/mL to 0.05 g/mL.

In any embodiment, the crystalline core may further comprise an oxide of iron and copper.

In any embodiment, the coating may be selected from: polyethylenimine, polyvinylpyrrolidone, and a mixture of polyethylenimine and polyvinylpyrrolidone.

In any embodiment of the method, the nanoparticle may have a hydrodynamic diameter of from about 50 nm to about 175 nm. In any embodiment, the nanoparticle may have a diameter of about 5 nm to about 15 nm.

In any embodiment of the method, the method may further comprise, after the step of contacting a germination-capable plant tissue with the aqueous fertilizer for a period of time prior to germination of the germination-capable plant tissue, sowing the germination-capable plant tissue in a soil that, optionally, may be fertilized with nitrate-phosphate-potassium fertilizer.

### BRIEF DESCRIPTION OF THE DRAWINGS

The accompanying figures, which are incorporated in and constitute part of this specification, illustrate exemplary embodiments of the compositions and methods of the present disclosure, and, together with the summary given above and detailed description given below, serve to explain aspects of the present disclosure.

FIGS. 1A-1C illustrate increase in seed germination rate of three different legumes using zinc oxide nanofertilizer and copper-zinc-iron oxide nanofertilizer formulations (n=7 for each experimental group). FIG. 1A shows germination rates for chickpea; FIG. 1B shows germination rates for pea; and FIG. 1C shows germination rate for green gram (Latin name Vigna radiata, also sometimes called “mung bean”, “maash”, among other common names).

FIGS. 2A-2B are photographs of 14-day-post-germination pea specimen treated pre-germination with zinc oxide nanofertilizer; treated pre-germination with copper-zinc-iron oxide nanofertilizer; and negative control, planted in soil treated with “traditional” nitrogen-phosphorus-potassium (NPK) fertilizer (FIG. 2A) and planted in untreated soil (FIG. 2B).

FIGS. 3A-3B are photographs of 15-day-post-germination pea specimen treated pre-germination with zinc oxide nanofertilizer; treated pre-germination with copper-zinc-iron oxide nanofertilizer; and negative control, planted in soil treated with traditional (NPK) fertilizer (FIG. 3A) and planted in untreated soil (FIG. 3B).

FIGS. 4A-4B are line graphs showing plant height in for zinc oxide nanofertilizer pre-treated pea; copper-zinc-iron oxide nanofertilizer pre-treated pea; and negative control pea for specimens planted in NPK-fertilized soil (FIG. 4A) and unfertilized soil (FIG. 4B). Error bars represent standard deviation.

FIG. 5 shows quantitative comparison of root length, root diameter, shoot length, and leaf quantity for zinc oxide nanofertilizer pre-treated pea; copper-zinc-iron oxide nanofertilizer pre-treated pea; and negative control pea plants. Error bars represent 95% confidence interval (n=2 for each experimental group). These specimens were taken from soils without NPK fertilizer.

FIG. 6 shows quantitative comparison of plant mass for zinc oxide nanofertilizer pre-treated pea; copper-zinc-iron oxide nanofertilizer pre-treated pea; and negative control pea plants. Error bars represent 95% confidence interval. These specimens were taken from soils without NPK fertilizer.

FIGS. 7A-7C are photographs of uprooted negative control pea (FIG. 7A); zinc oxide nanofertilizer pre-treated pea (FIG. 7B); and copper-zinc-iron oxide nanofertilizer pre-treated pea (FIG. 7C), showing root, shoot, and leaf system.

FIG. 8 shows Fourier transform infrared spectroscopy (FTIR) characterization of the leaves after 35 days of growth from zinc oxide nanofertilizer pre-treated pea; copper-zinc-iron oxide nanofertilizer pre-treated pea; and negative control pea plant specimens. The surface functional groups and FTIR profile of the leaves from all three plants were similar, indicating that the nanofertilizers have been used in the biological processes by the plants.

FIGS. 9A-9B are line graphs showing plant height in for zinc oxide nanofertilizer pre-treated green gram; copper-zinc-iron oxide nanofertilizer pre-treated green gram; and negative control green gram for specimens planted in NPK-fertilized soil (FIG. 9A) and unfertilized soil (FIG. 9B). Error bars represent standard deviation.

FIGS. 10A-10D are photographs of green gram specimens treated pre-germination with zinc oxide nanofertilizer; treated pre-germination with copper-zinc-iron oxide nanofertilizer; and negative control green gram, planted in soil treated with traditional (NPK) fertilizer and planted in untreated soil, after 11 days (FIG. 10A), 14 days (FIG. 10B), 15 days (FIG. 10C), and 21 days post-germination (FIG. 10D).

FIGS. 11A-11B are line graphs showing plant height in for zinc oxide nanofertilizer pre-treated corn (also sometimes called maize); copper-zinc-iron oxide nanofertilizer pre-treated corn; and negative control corn for specimens planted in NPK-fertilized soil (FIG. 11A) and unfertilized soil (FIG. 11B). Error bars represent standard deviation.

FIGS. 12A-12D are photographs of corn specimens treated pre-germination with zinc oxide nanofertilizer; treated pre-germination with copper-zinc-iron oxide nanofertilizer; and negative control corn, planted in soil treated with traditional (NPK) fertilizer and planted in untreated soil, after 14 days (FIG. 12A), 15 days (FIG. 12B), 21 days (FIG. 12C), and 30 days post-germination (FIG. 12D).

FIGS. 13A-13B are line graphs showing plant height in for zinc oxide nanofertilizer pre-treated chickpea; copper-zinc-iron oxide nanofertilizer pre-treated chickpea; and negative control chickpea for specimens planted in NPK-fertilized soil (FIG. 13A) and unfertilized soil (FIG. 13B). Error bars represent standard deviation.

FIGS. 14A-14B are photographs of chickpea specimens treated pre-germination with zinc oxide nanofertilizer; treated pre-germination with copper-zinc-iron oxide nanofertilizer; and negative control chickpea at 28 days post-germination in NPK-fertilized soil (FIG. 14A) and unfertilized soil (FIG. 14B).

FIG. 15A-15B are line graphs showing plant height in for zinc oxide nanofertilizer pre-treated bean; copper-zinc-iron oxide nanofertilizer pre-treated bean; and negative control bean for specimens planted in NPK-fertilized soil (FIG. 15A) and unfertilized soil (FIG. 15B). Error bars represent standard deviation.

FIG. 16 is a photograph of bean specimens treated pre-germination with zinc oxide nanofertilizer; and treated pre-germination with copper-zinc-iron oxide nanofertilizer at 23 days post-germination in NPK-fertilized soil (right) and unfertilized soil (left).

FIG. 17 is a photograph of a field experiment test plot.

FIGS. 18A-18B are graphs of plant height (FIG. 18A) and plant area (FIG. 18B) comparing various nanofertilizer composition treated grass test specimens with negative control.

FIG. 19 is a photograph of another field experiment test plot, pictured at the time of sowing of garbanzo bean test specimens.

FIG. 20 is a photograph of the same field experiment test plot of FIG. 19, shown in this figure at t=44 days after sowing of garbanzo bean test specimens.

FIG. 21 is a line graph plotting plant length comparing various nanofertilizer composition treated garbanzo bean test specimens with negative control.

FIGS. 22A-22B show dynamic light scattering data (DLS) characterization of copper-zinc-iron oxide nanofertilizers. FIG. 22A shows zeta potential in millivolts, and FIG. 22B shows hydrodynamic diameter.

FIGS. 23A-23B show DLS characterization of zinc oxide nanofertilizers. FIG. 23A shows zeta potential in millivolts, and FIG. 23B shows hydrodynamic diameter.

FIG. 24 shows x-ray diffraction (XRD) characterization of zinc oxide nanofertilizers.

FIG. 25 shows XRD characterization of copper-zinc-iron oxide nanofertilizers.

FIG. 26 is a transmission electron microscopy image of copper-zinc-iron oxide nanofertilizer particles of the present disclosure. Scale bar is 20 nm. The pictured particles are about 8 nanometers in diameter.

FIG. 27 is a flow diagram showing steps of an exemplary embodiment of a method of the present disclosure. A dashed line indicates an optional step of the method.

### DETAILED DESCRIPTION

Novel nanofertilizer compositions and methods are reported in the present disclosure for effectively increasing the germination rate, growth, and yield of a wide variety of crops with application of milliliter-scale quantities of the nanofertilizer.

Currently, agricultural growers all over the world are facing a challenge to increase agricultural yields to combat rising global food and energy insecurity. The COVID-19 pandemic has induced an added global shock in the food and agri-tech sectors. There is a substantial need for a market disruptor. Traditional nitrogen-phosphorus-potassium (NPK) bulk fertilizers have to be added in soil in huge excess as they are not readily available for uptake by the plants. This increases both the cost of farming as well as the detrimental environmental impact such as leaching to surrounding waterbodies and increase in greenhouse gas emission from the production of nitrogen-based fertilizers. There is a huge push towards green and more sustainable products in the global agri-tech market. The major fertilizer and seed companies as well as the farmers worldwide are seeking more sustainable, efficient, and cost-effective alternatives to enhance agricultural production. This disclosure will galvanize the global agricultural market through sustainability and innovation. The present disclosure represents a breakthrough for the global agricultural market, which at the time of the present disclosure is valued at over $155 billion.

The present disclosure provides nanofertilizer compositions and methods, by which micronutrients (e.g., zinc, copper, and iron) may be packaged in a nanoscale unit (e.g., a particle) with a biocompatible coating for facile delivery and easy uptake by germination-capable plant tissue (e.g., a seed). One drop of aqueous solution containing the nanofertilizer composition is sufficient to boost plant germination rate, growth, and vitality over the plant's lifespan. This improvement brings groundbreaking benefits for both producers and consumers, from cost and environmental sustainability perspectives—particularly in comparison with current bulk fertilizers that must be applied to the soil in huge excess of the plants' biomolecular requirements.

This innovative technology in the form of novel zinc oxide-based nanofertilizers realizes breakthrough advancement in agricultural production in terms of enhanced growth, yield, and vitality in a wide variety of crops through a unique and environmentally-friendly seed pre-soak strategy. Multiple groundbreaking approaches are realized in this disclosure, packaging single to multiple micronutrients that are tailored to the plant's needs within a nanoscale unit to facilitate easy absorption by the plants as compared to the bulk fertilizers and using a novel seed pre-soak technique where a single drop of the nanofertilizer formulation is sufficient for sustained growth enhancement of the plant. These nanofertilizer formulations are effective at negligible quantities per plant and are not added directly to the soil or the surrounding environment, making them a niche from environmental and materials sustainability aspects.

Zinc is a key micronutrient that is used by plants for synthesizing various proteins for carbohydrate production and activating enzymes for the synthesis of chlorophyll. The zinc oxide-based nanofertilizer products of the present disclosure facilitate an increase in the germination rate of test crops, enhancement in the growth of test crops, and significant boost in the vitality of the plant in terms of plant biomass. Therefore, the new nanofertilizer formulations will bring groundbreaking benefits for the agricultural market both from the perspectives of environmental sustainability and input cost per yield.

Various quantities, such as amounts, sizes, dimensions, proportions, and the like, are presented herein in a range format throughout this disclosure. It should be understood that the description of a quantity in range format is merely for convenience and brevity and should not be construed as an inflexible limitation on the scope of any embodiment. Accordingly, the description of a range should be considered to have specifically disclosed all the possible subranges as well as all individual numerical values within that range unless the context clearly dictates otherwise. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual values within that range, for example, 1.1, 2, 2.3, 4.62, 5, and 5.9. This applies regardless of the breadth of the range. The upper and lower limits of these intervening ranges may independently be included in the smaller ranges, and are also encompassed within the disclosure, subject to any specifically excluded limit in the stated range. Where the stated range includes one or both of the limits, ranges excluding either or both of those included limits are also included in the disclosure, unless the context clearly dictates otherwise.

The terminology used herein is to describe particular embodiments only and is not intended to be limiting of any embodiment. As used herein, the singular forms “a,” “an”, and “the” are intended to include the plural forms as well, unless the context clearly indicates otherwise. It will be further understood that the terms “includes”, “comprises”, “including” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Unless expressly stated or obvious from context, as used herein, the term “about” in reference to a number or range of numbers is understood to mean the stated number and numbers +/−10% thereof, or 10% below the lower listed limit and 10% above the higher listed limit for the values listed for a range.

In an aspect, the present disclosure provides a nanofertilizer composition comprising a particle, the particle comprising a crystalline core comprising zinc oxide, a coating covering a surface area of the crystalline core, the coating comprising a biocompatible polymer. In any embodiment, the crystalline core may further comprise an oxide of copper and oxide of iron. In any embodiment, the crystalline core may comprise a mixture of cubic-phase Cu₄Zn₆Fe₂O₄ and trigonal hematite. In any embodiment, the relative molar amounts in the crystal of zinc, copper, and iron may be about 1:1:8. In any embodiment, the coating may coat from about 50% to 100% the surface area of the particle. In any embodiment, the coating may coat substantially all of the surface area of the particle.

The zinc oxide may be characterized by x-ray diffraction peaks of 31.8°, 34.5°, 36.3°, 47.6°, 56.7°, 63.0°, 67.0°, 68.1°, 69.2°, 72.8°, 77.1°, 81.8°, and 89.6° corresponded to the (100), (002), (101), (102), (110), (103), (200), (112), (201), (004), (202), (104), and (203) crystal planes of wurtzite phase. The mixture of cubic-phase Cu₄Zn₆Fe₂O₄ and trigonal hematite may be characterized by x-ray diffraction peaks corresponding to 2θ angles of 18.2°, 30.1°, 35.7°, 37.0°, 43.0°, 53.4°, 56.9°, 62.5°, and 73.9°, indexed to the (111), (220), (311), (222), (400), (422), (511), (440), and (533) crystal planes of cubic-phase Cu₄Zn₆Fe₂O₄ based on the Inorganic Crystal Structure Database (ICSD) and XRD peak at 49.9° corresponding to (024) plane of hematite.

Compositions of the present disclosure may be synthesized by a modified polyol method using a Schlenk line technique. In an exemplary approach, a biocompatible polymer mixture (comprising, e.g., a mixture of polyethylenimine and polyvinylpyrrolidone) is purged in nitrogen atmosphere and dissolved in triethylene glycol (TEG) solvent at 90° C. for 10 minutes. Zinc precursor, zinc acetylacetonate (Zn(acac)₂) is added to the reaction mixture and stirred for 30 minutes, prior to heating up to 290° C. for one hour to form zinc oxide nanoparticles. Embodiments of compositions of the present disclosure may be synthesized from a mixture of zinc acetylacetonate (Zn(acac)₂) precursor, copper (II) acetylacetonate (Cu(acac)₂) precursor, and iron (III) 2,4-pentadionate precursor (Fe(acac)₃).

Suitable biocompatible polymer coatings include, but are not limited to, alginate, cellulose, chitosan, collagen, gelatin, polyethylenimine (PEI), polylactic-co-glycolic acid, poly(ε-caprolactone) (PCL), poly(lactic acid) (PLA), poly(3-hydroxybutyrate-co-3-hydroxyvalerate) (PHBV), polyvinylpyrrolidone (PVP), and any mixture thereof. In any embodiment of the nanofertilizer composition, the coating may be selected from: polyethylenimine, polyvinylpyrrolidone, and a mixture of polyethylenimine and polyvinylpyrrolidone. In any embodiment, the biocompatible polymer may be biodegradable, bioresorbable, or biodegradable and bioresorbable.

In any embodiment, the zinc oxide of the crystalline core may comprise a crystal structure selected from: hexagonal, cubic, and a mixture of hexagonal and cubic.

When a dispersed nano-scale particle moves through liquid medium, a thin electric dipole layer may adhere to its surface. The particles in liquid medium can also form assemblages. This layer and/or tendency to assemble into aggregates influences the movement of the particles, and may be measured and characterized as “hydrodynamic diameter” (Dh). Hydrodynamic diameter may be measured by dynamic light scattering (DLS) and is generally larger than the physical diameter measured, for example, by transmission electron microscopy (TEM). In any embodiment, the particle of the present disclosure may have hydrodynamic diameter of about 50 nm to about 250 nm, or anything in between. In any embodiment, the particle of the present disclosure may have hydrodynamic diameter of about 50 nm to about 175 nm. For example, the particle may have a hydrodynamic diameter of 45 nm, 50 nm, 55 nm, 60 nm, 65 nm, 70 nm, 75 nm, 80 nm, 85 nm, 90 nm, 100 nm, 105 nm, 110 nm, 115 nm, 120 nm, 125 nm, 130 nm, 135 nm, 140 nm, 145 nm, 150 nm, 155 nm, 160 nm, 165 nm, 170 nm, 175 nm, 180 nm, 185 nm, 190 nm, 195 nm, 200 nm, 205 nm, 210 nm, 215 nm, 220 nm, 225 nm, 230 nm, 235 nm, 240 nm, 245 nm, 250 nm, 255 nm, 260 nm, 265 nm, 270 nm, 275 nm, 280 nm, 285 nm, 290 nm, 295 nm, 300 nm, or even greater.

Diameter, i.e., physical diameter (as opposed to hydrodynamic diameter) may be directly measured by microscopy observation, e.g., by transmission electron microscopy imaging. In any embodiment, the particle of the present disclosure may have a physical diameter of about 1 nm to about 30 nm. In any embodiment, the particle may have a physical diameter of about 5 nm to about 15 nm. For example, the particle may have a diameter of 0.5 nm, 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, or even more.

In any embodiment, the particle may have a surface charge of about −10 millivolts to about 50 millivolts, or any number in between. In any embodiment, the particle may have a surface charge of about 1 millivolts to about 35 millivolts.

In another aspect, the present disclosure provides a fertilizer composition comprising an aqueous solution comprising the nanofertilizer composition described herein. The nanofertilizer particles may be in suspension, dispersion, or in a colloidal solution. The nanofertilizer particles may be in a concentration of from 0.01 grams of nanofertilizer particles per milliliter of aqueous solution to 0.1 grams of nanofertilizer particles per milliliter of aqueous solution. The nanofertilizer particles may be in a concentration of from 0.02 grams of nanofertilizer particles per milliliter of aqueous solution to 0.04 grams of nanofertilizer particles per milliliter of aqueous solution. The nanofertilizer particles may be in a concentration of from 0.025 grams of nanofertilizer particles per milliliter of aqueous solution to 0.028 grams of nanofertilizer particles per milliliter of aqueous solution. The nanofertilizer particles may be in a concentration of, for example, 0.01 g/mL, 0.0125 g/mL, 0.015 g/mL, 0.0175 g/mL, 0.02 g/mL, 0.0225 g/mL, 0.025 g/mL, 0.0275 g/mL, 0.03 g/mL, 0.0325 g/mL, 0.035 g/mL, 0.0375 g/mL, 0.04 g/mL, 0.0425 g/mL, 0.045 g/mL, 0.0475 g/mL, or 0.05 g/mL, 0.0525 g/mL, 0.055 g/mL, 0.0575 g/mL, 0.06 g/mL, 0.0625 g/mL, 0.065 g/mL, 0.0675 g/mL, 0.07 g/mL, 0.0725 g/mL, 0.075 g/mL, 0.0775 g/mL, 0.08 g/mL, 0.0825 g/mL, 0.845 g/mL, 0.0875 g/mL, 0.09 g/mL, 0.0925 g/mL, 0.945 g/mL, 0.0975 g/mL, or 0.1 g/mL, or even more. The nanofertilizer particles may be in a concentration of 0.022 g/L.

In still another aspect, the present disclosure provides a nanofertilizer particle comprising a crystalline core comprising a mixture of oxide of zinc, oxide of iron, and oxide of copper, and a coating covering a surface area of the crystalline core, the coating comprising a biocompatible polymer comprising polyethylenimine, polyvinylpyrrolidone, or a mixture of polyethylenimine and polyvinylpyrrolidone. The mixture of oxide of zinc, oxide of iron, and oxide of copper may comprise a cubic-phase Cu₄Zn₆Fe₂O₄ crystal. The mixture of oxide of zinc, oxide of iron, and oxide of copper may be characterized by x-ray diffraction peaks corresponding to 2θ angles of 18.2°, 30.1°, 35.7°, 37.0°, 43.0°, 53.4°, 56.9°, 62.5°, and 73.9°, indexed to the (111), (220), (311), (222), (400), (422), (511), (440), and (533) crystal planes of cubic-phase Cu₄Zn₆Fe₂O₄ based on the Inorganic Crystal Structure Database (ICSD).

In a further aspect, the present disclosure provides a method of enhancing plant growth, the method comprising contacting a germination-capable plant tissue with an aqueous fertilizer for a period of time prior to germination of the germination-capable plant tissue, wherein the aqueous fertilizer comprises a solution comprising a nanofertilizer composition comprising a nanoparticle, the nanoparticle comprising a crystalline core comprising zinc oxide, and a coating covering a surface area of the crystalline core, the coating comprising a biocompatible polymer. It should be understood that germination-capable plant tissue may refer to a seed (including those of an angiosperm or gymnosperm), tuber (such as a potato or sweet potato, or cutting thereof), or sporophyte spore.

In any embodiment of the method, the germination-capable plant tissue may be a seed of maize. In any embodiment, the germination-capable plant tissue may be a seed of a legume. In any embodiment, the legume may be selected from: chickpea, green bean, green gram, and pea.

In any embodiment, the volume of the aqueous fertilizer contacted to the germination-capable plant tissue may be about 0.01 mL to 0.1 mL. For example, the volume contacted to the germination-capable plant tissue may be 0.01 mL, 0.02 mL, 0.03 mL, 0.04 mL, 0.05 mL, 0.06 mL, 0.06 mL, 0.07 mL, 0.08 mL, 0.09 mL, or 0.1 mL. In any embodiment, the volume of aqueous fertilizer contacted to the germination-capable plant tissue may be about 0.05 mL.

In any embodiment, the mass of nanofertilizer composition in the volume of aqueous fertilizer may be about 0.1 mg to 3 mg. For example, a volume of aqueous fertilizer may have dissolved in it 0.1 mg, 0.2 mg, 0.3 mg, 0.4 mg, 0.5 mg, 0.6 mg, 0.7 mg, 0.8 mg, 0.9 mg, 1.0 mg, 1.1 mg, 1.2 mg, 1.3 mg, 1.4 mg, 1.5 mg, 1.6 mg, 1.7 mg, 1.8 mg, 1.9 mg, 2.0 mg, 2.1 mg, 2.2 mg, 2.3 mg, 2.4 mg, 2.5 mg, 2.6 mg, 2.7 mg, 2.8 mg, 2.9 mg, 3.0 mg of nanofertilizer composition.

In any embodiment, the concentration of nanofertilizer composition in the solution may be 0.01 g/mL to 0.05 g/mL. In any embodiment, the concentration of nanofertilizer composition in the solution may be 0.02 g/mL to 0.04 g/mL. In any embodiment, the concentration of nanofertilizer composition in the solution may be 0.025 g/mL to 0.028 g/mL. In any embodiment, the concentration of nanofertilizer composition in the solution may be 0.0260 g/mL to 0.0271 g/mL. In any embodiment, concentration of nanofertilizer composition in the solution may be 0.01 g/mL, 0.0125 g/mL, 0.015 g/mL, 0.0175 g/mL, 0.02 g/mL, 0.0225 g/mL, 0.025 g/mL, 0.0275 g/mL, 0.03 g/mL, 0.0325 g/mL, 0.035 g/mL, 0.0375 g/mL, 0.04 g/mL, 0.0425 g/mL, 0.045 g/mL, 0.0475 g/mL, or 0.05 g/mL. In any embodiment, the crystalline core may further comprise an oxide of iron, zinc, and copper.

In any embodiment, the coating may be selected from: polyethylenimine, polyvinylpyrrolidone, and a mixture of polyethylenimine and polyvinylpyrrolidone.

In any embodiment of the method, the nanoparticle may have a hydrodynamic diameter of from about 50 nm to about 175 nm. In any embodiment, the nanoparticle may have a diameter of about 5 nm to about 15 nm.

In any embodiment of the method, the method may further comprise, after the step of contacting a germination-capable plant tissue with the aqueous fertilizer for a period of time prior to germination of the germination-capable plant tissue, sowing the germination-capable plant tissue in a soil that, optionally, is fertilized with nitrate-phosphate-potassium fertilizer.

The present disclosure may be further understood by reference to the following clauses:

Clause 1. A nanofertilizer composition comprising a particle, the particle comprising a crystalline core comprising zinc oxide, and a coating covering a surface area of the crystalline core, the coating comprising a biocompatible polymer.

Clause 2. The nanofertilizer composition of clause 1, wherein the crystalline core further comprises an oxide of copper and oxide of iron.

Clause 3. The nanofertilizer composition of clause 2, wherein the crystalline core comprises a mixture of cubic-phase Cu₄Zn₆Fe₂O₄ and trigonal hematite.

Clause 4. The nanofertilizer composition of clause 2, wherein the relative molar amounts in the crystal of zinc, copper, and iron is about 1:1:8.

Clause 5. The nanofertilizer composition of clause 1, wherein the coating is selected from: polyethylenimine, polyvinylpyrrolidone, and a mixture of polyethylenimine and polyvinylpyrrolidone.

Clause 6. The nanofertilizer composition of clause 1, wherein the zinc oxide of the crystalline core comprises a crystal structure selected from: hexagonal, cubic, and a mixture of hexagonal and cubic.

Clause 7. The nanofertilizer composition of clause 1, wherein the particle has a hydrodynamic diameter of about 50 nm to about 175 nm.

Clause 8. The nanofertilizer composition of clause 1, wherein the particle has a diameter of about 5 nm to about 15 nm.

Clause 9. A fertilizer composition comprising an aqueous solution comprising the nanofertilizer composition of clause 1.

Clause 10. A nanofertilizer particle comprising a crystalline core comprising a mixture of oxide of zinc, oxide of iron, and oxide of copper, and a coating covering a surface area of the crystalline core, the coating comprising a biocompatible polymer comprising polyethylenimine, polyvinylpyrrolidone, or a mixture of polyethylenimine and polyvinylpyrrolidone.

Clause 11. A method of enhancing plant growth, the method comprising contacting a germination-capable plant tissue with an aqueous fertilizer for a period of time prior to germination of the germination-capable plant tissue, wherein the aqueous fertilizer comprises a solution comprising a nanofertilizer composition comprising a nanoparticle, the nanoparticle comprising a crystalline core comprising zinc oxide, and a coating covering a surface area of the crystalline core, the coating comprising a biocompatible polymer.

Clause 12. The method of clause 11, wherein the germination-capable plant tissue is a seed of maize.

Clause 13. The method of clause 11, wherein the germination-capable plant tissue is a seed of a legume.

Clause 14. The method of clause 13, wherein the legume is selected from: chickpea, green bean, green gram, and pea.

Clause 15. The method of clause 11, wherein the volume of the aqueous fertilizer contacted to the germination-capable plant tissue is 0.01 mL to 0.1 mL.

Clause 16. The method of clause 15, wherein the mass of nanofertilizer composition in the volume of aqueous fertilizer is about 0.1 mg to 3 mg.

Clause 17. The method of clause 11, wherein the concentration of nanofertilizer composition in the solution is 0.01 g/mL to 0.05 g/mL.

Clause 18. The method of clause 11, wherein the crystalline core further comprises an oxide of iron and copper.

Clause 19. The method of clause 11, wherein the coating is selected from: polyethylenimine, polyvinylpyrrolidone, and a mixture of polyethylenimine and polyvinylpyrrolidone.

Clause 20. The method of clause 11, wherein the nanoparticle has a hydrodynamic diameter of from about 50 nm to about 175 nm.

Clause 21. The method of clause 11, wherein the nanoparticle has a diameter of about 5 nm to about 15 nm.

Clause 22. The method of clause 11, further comprising, after the step of contacting a germination-capable plant tissue with the aqueous fertilizer for a period of time prior to germination of the germination-capable plant tissue, sowing the germination-capable plant tissue in a soil that, optionally, is fertilized with nitrate-phosphate-potassium fertilizer.

### EXAMPLES

The present disclosure may be further understood by reference to the following examples, which include nanofertilizer germination experiments, growth measurement and characterization, synthesis methods, and a multimodal characterization of compositions of the present disclosure.

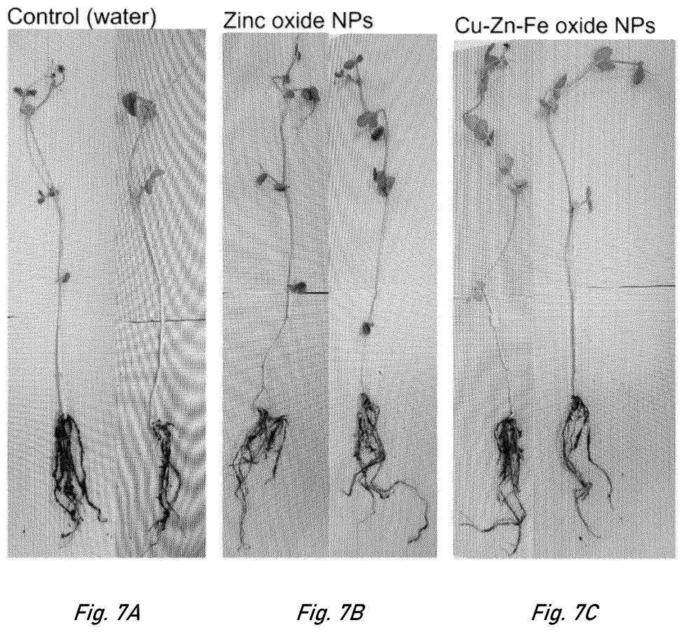

Each of the laboratory-based growth experiments described below consisted of a pre-germination phase, a planting step, and growth monitoring phase. The zinc oxide-based and copper-zinc-iron oxide-based nanofertilizer samples were added one time to the seeds during the pre-germination stage. The seeds of the respective crops were placed on a moist paper towel in a petri-dish. One drop (˜0.05 mL) of the nanofertilizer of the desired concentration of 0.0262 to 0.02705 g/mL was added per seed during the pre-germination while a drop of water was added for the control seeds. The seeds were watered at regular intervals and kept in the moist environment of the petri-dish for seven days. The germination rates and root lengths of the seeds were monitored during this time. The seeds were planted in potted soil after seven days of germination. Two types of soil were used for each class of seeds, untreated soil without any additional fertilizer and fertilized soil with 5 mL of RAW™ All-In-One 7-4-5 nitrogen-phosphorus-potassium fertilizer (NPK Industries, LLC, Medford, OR, USA) added to the soil. Control as well as the nanofertilizer treated seeds were planted in both types of soil. The plant height and number of leaves were monitored daily to estimate the influence of the nanofertilizer on the growth rate of the various crops. After approximately 30 to 45 days of growth, the root span, root length, and final biomass of the plants were also measured by uprooting the plants from the soil (e.g., FIGS. 7A-7C for pea plants).

### Example 1. Pre-Treatment of Seeds with Nanofertilizer Effect on Germination Rate

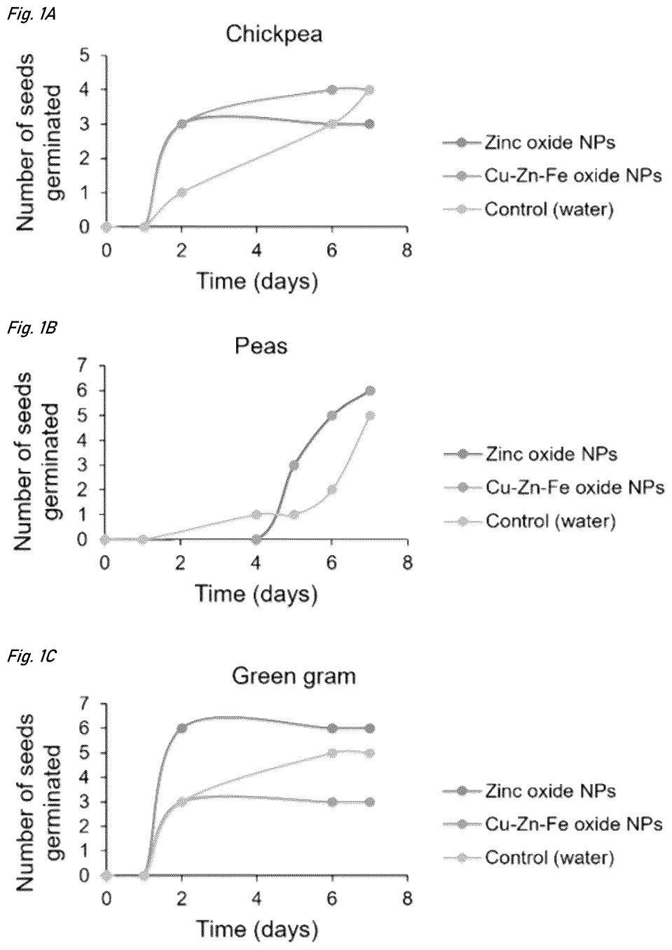

Experimental groups of seeds of chickpea (FIG. 1A), pea (FIG. 1B), and green gram (FIG. 1C) were pre-treated with one drop of zinc oxide-based nanofertilizer composition and copper-zinc-iron oxide-based nanofertilizer composition in a concentration of 0.0262 to 0.02705 g/mL and seeds then kept moist in a petri dish for seven days and then sown. Experimental groups included pre-treatment with zinc oxide-based nanofertilizer (n=3-7); pre-treatment with copper-zinc-iron nanofertilizer (n=3-7); and negative control seeds (n=3-7) which were not pre-treated with nanofertilizer composition. In all experimental groups, the particles of the nanofertilizer composition were coated in PVP/PEI. The seeds were then sown in soil without NPK fertilizer and then observed for germination. Germination rate was accelerated in experimental groups over that of the negative control.

### Example 2. Pre-Treatment of Pea Seeds with Nanofertilizer Effect on Growth

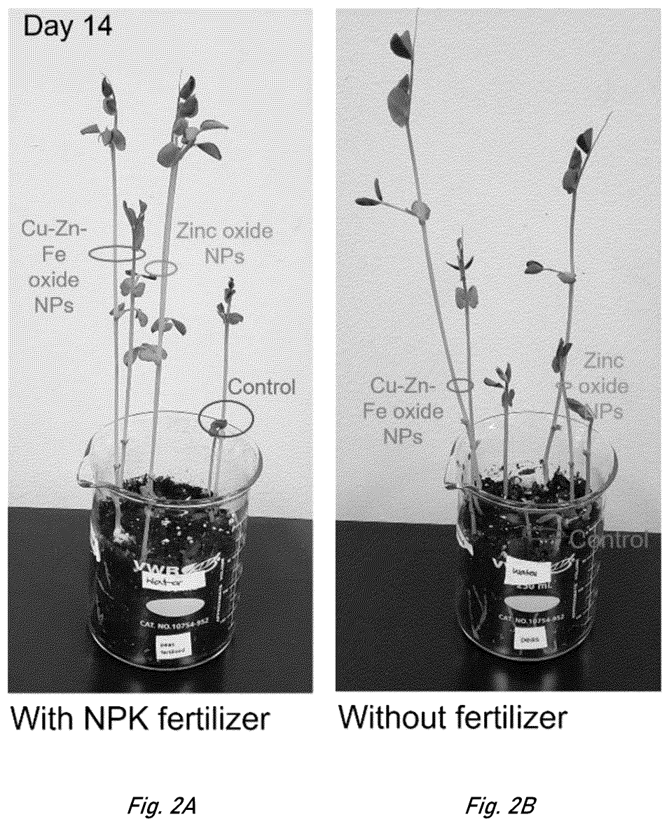

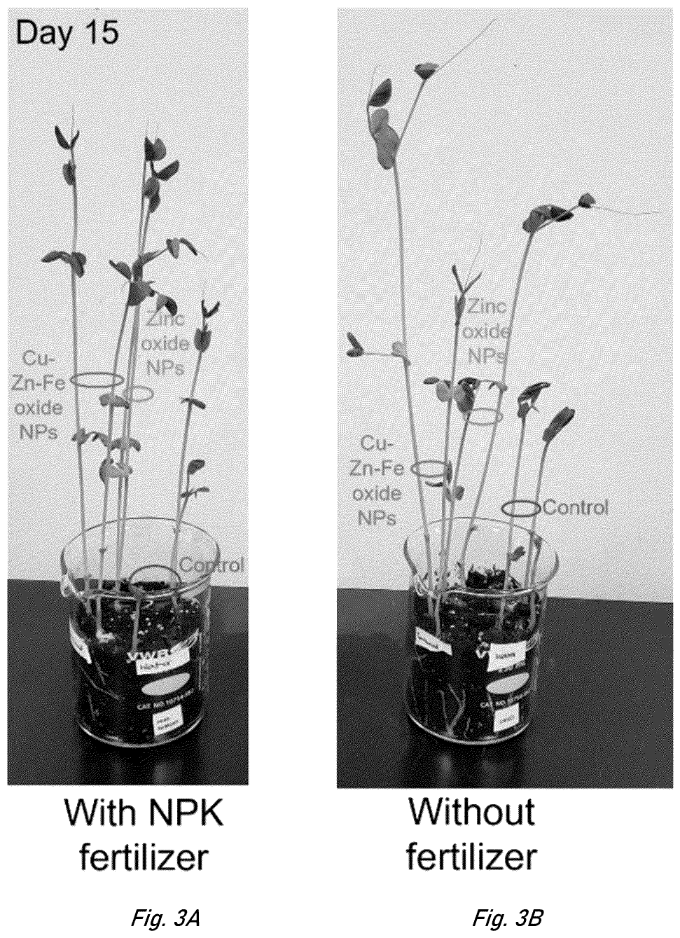

Pea seeds were pre-soaked according to the same protocol described above, and sown in soil treated with nitrogen-phosphorus-potassium fertilizer (FIG. 2A, 3A) and untreated soil (FIG. 2B, 3B), and growth observed.

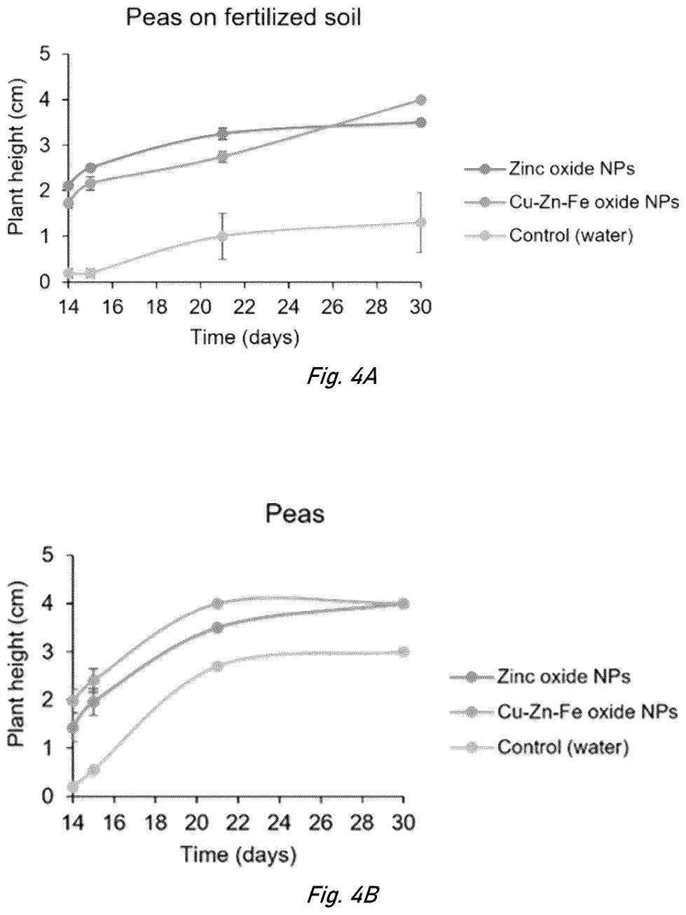

Plant height measurements at 14, 15, 21, and 30 days show nanofertilizer pre-treated specimens significantly taller than negative control in both fertilized (FIG. 4A) and unfertilized (FIG. 4B) soils.

### Example 3. Pre-Treatment of Pea Seeds with Nanofertilizer Effect on Root and Leaf System

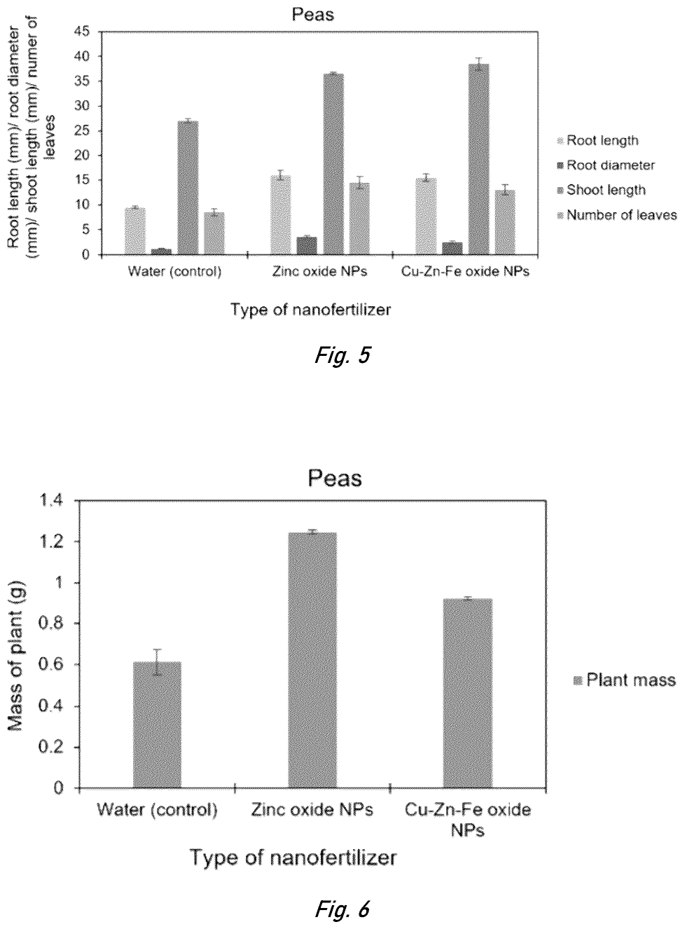

Pre-treatment with zinc oxide-based nanofertilizer and copper-zinc-iron oxide-based nanofertilizer facilitated marked improvement in the root and leaf systems of tested pea plants. Pea seeds were pre-soaked for seven days and sown, and after 30 days of growth were uprooted and measured. Treated pea plants had improved root length, root diameter, shoot length, and leaf quantity (FIG. 5) over negative control, and greater plant mass (FIG. 6) over negative control. Exemplary comparison specimens are shown at FIGS. 7A-7C.

### Example 4. Fourier Transform Infrared Spectroscopy (FTIR) Characterization of Pea Leaves

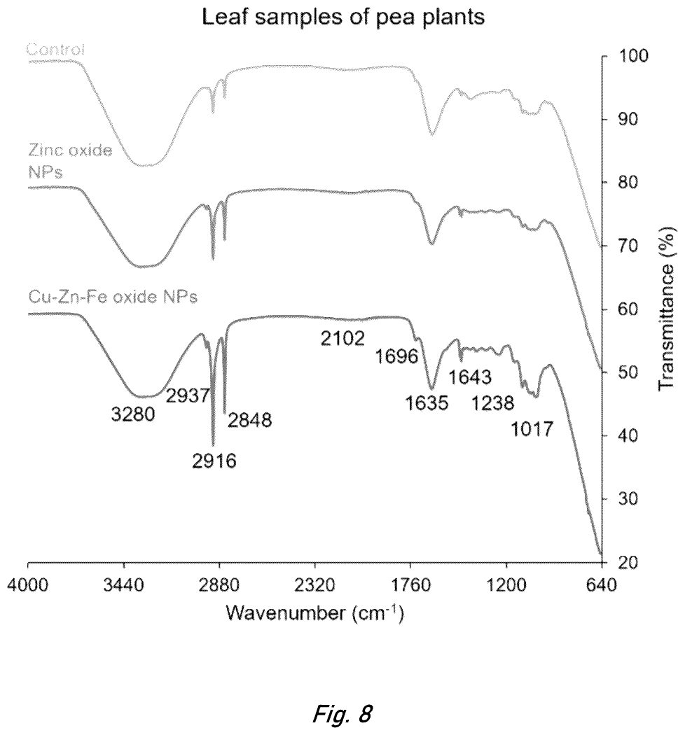

Leaves from zinc oxide-based nanofertilizer treated, copper-zinc-iron oxide-based nanofertilizer treated, and negative control pea plants after 35 days of growth were plucked and characterized by FTIR. (FIG. 8.) The surface functional groups and FTIR profile of the leaves from all three plants were similar, indicating that the nanofertilizers have been used in the biological processes by the plants.

### Example 5. Pre-Treatment of Green Gram Seeds with Nanofertilizer Effect on Growth

Green gram seeds were tested for growth performance of experimental group pre-treated with zinc oxide-based nanofertilizer, pre-treated with copper-zinc-iron oxide-based nanofertilizer, and negative control.

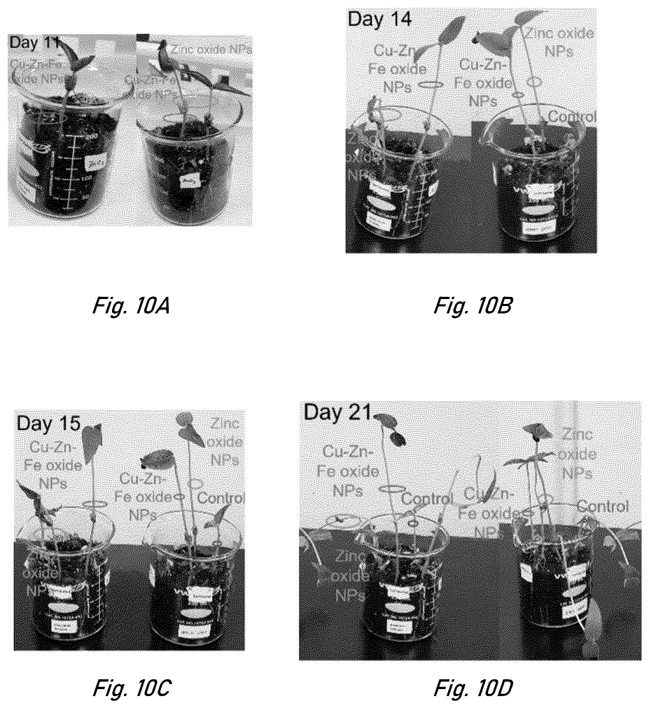

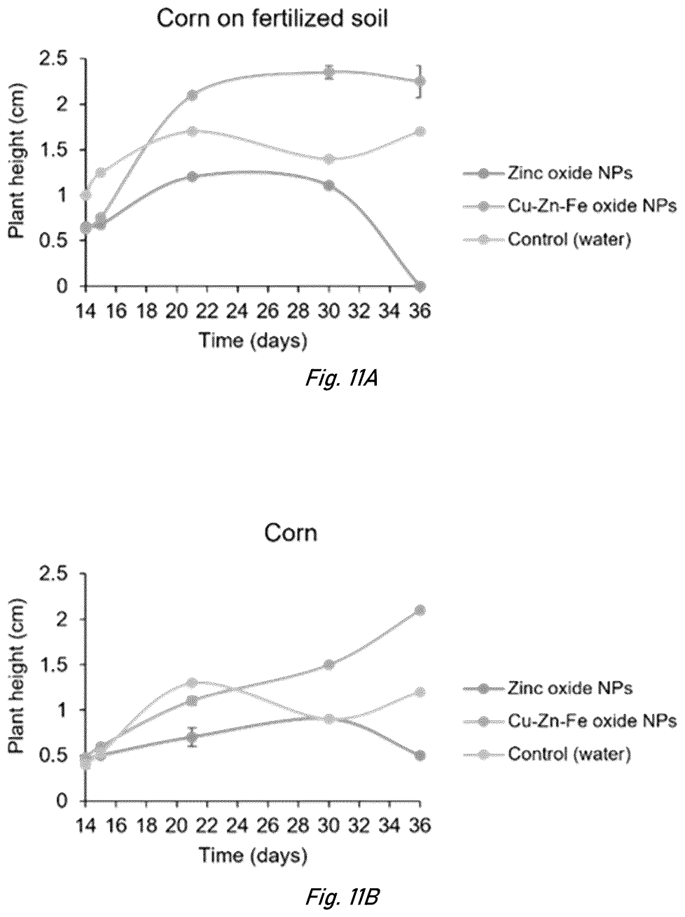

Green gram seeds were pretreated using the same protocol as described above and sown in soil treated with nitrogen-phosphorus-potassium fertilizer (left side of FIGS. 10A-10D) and untreated soil (right side of FIGS. 10A-10D), and growth observed.

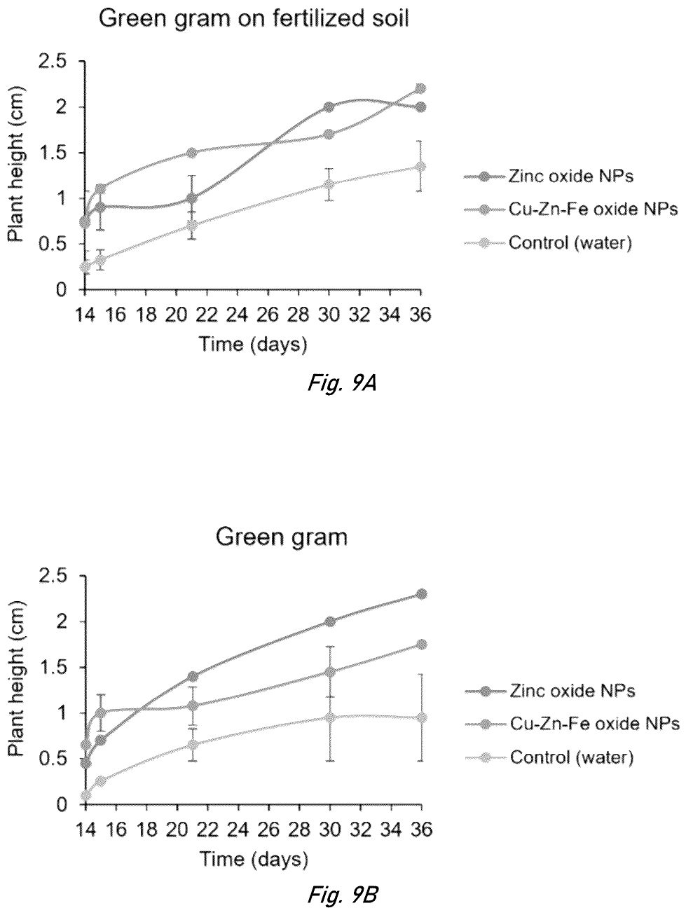

Plant height measurements at 14, 15, 21, 30, and 36 days show nanofertilizer pre-treated specimens of green gram significantly taller than negative control in both fertilized (FIG. 9A) and unfertilized (FIG. 9B) soils.

### Example 6. Pre-Treatment of Maize Seeds with Nanofertilizer Effect on Growth

Maize (i.e., corn) seeds were tested for growth performance of experimental group pre-treated with zinc oxide-based nanofertilizer, pre-treated with copper-zinc-iron oxide-based nanofertilizer, and negative control.

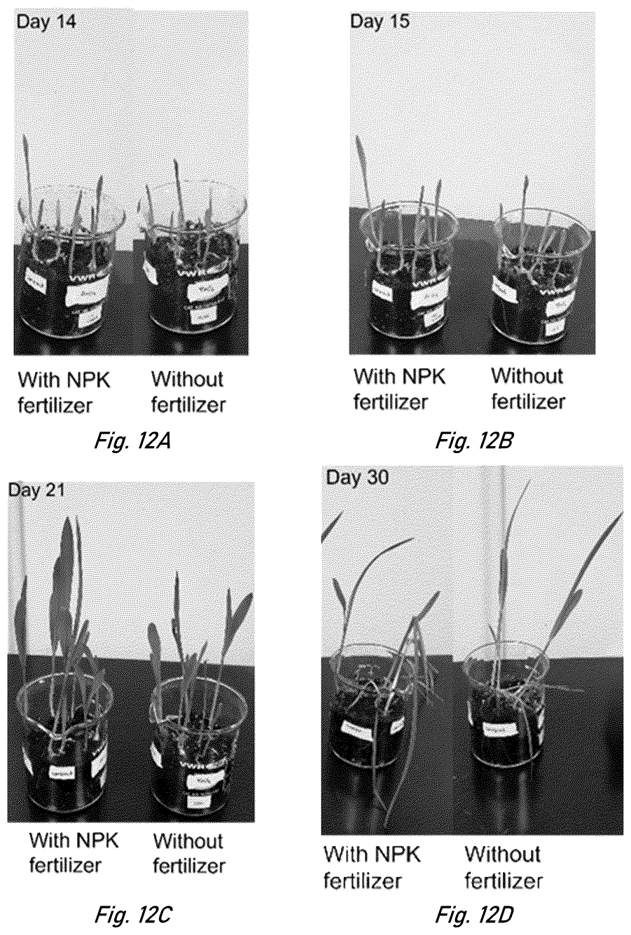

Maize seeds were pretreated using the same protocol as described above and sown in soil treated with nitrogen-phosphorus-potassium fertilizer (left side of FIGS. 12A-12D) and untreated soil (right side of FIGS. 12A-12D), and growth observed.

Plant height measurements at 14, 15, 21, 30, and 36 days show copper-zinc-iron nanofertilizer pre-treated specimens of maize significantly taller than negative control in both fertilized (FIG. 11A) and unfertilized (FIG. 11B) soils.

### Example 7. Pre-Treatment of Chickpea Seeds with Nanofertilizer Effect on Growth

Chickpea seeds were tested for growth performance of experimental group pre-treated with zinc oxide-based nanofertilizer, pre-treated with copper-zinc-iron oxide-based nanofertilizer, and negative control.

Chickpea seeds were pretreated using the same protocol as above, and sown in soil treated with nitrogen-phosphorus-potassium fertilizer (FIG. 14A) and untreated soil (FIG. 14B), and growth observed.

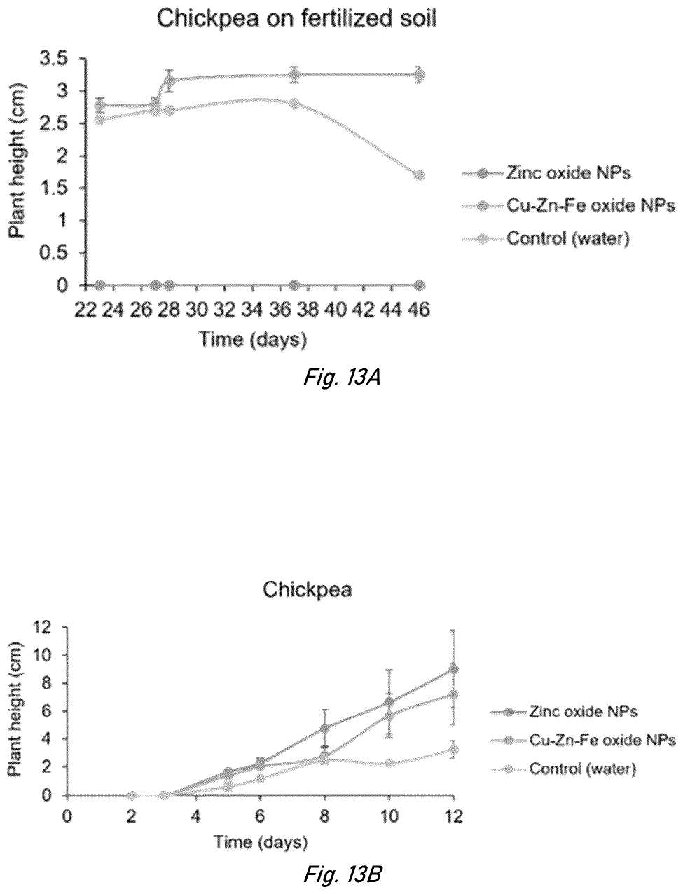

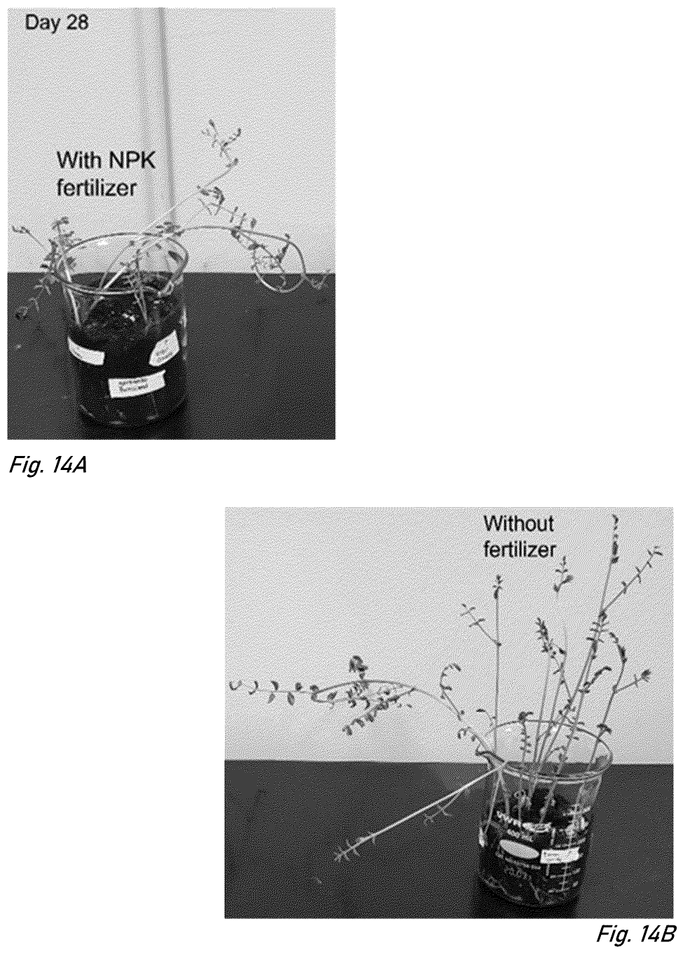

Plant height measurements at between 12 and 45 days show nanofertilizer pre-treated specimens of chickpea significantly taller than negative control in unfertilized (FIG. 13B) soils. In fertilized soil (FIG. 13A), the zinc-oxide pre-treated specimens failed to germinate; however, specimens pre-treated with copper-zinc-iron oxide based nanofertilizer were taller than negative control.

### Example 8. Pre-Treatment of Red Bean Seeds with Nanofertilizer Effect on Growth

Red bean seeds were tested for growth performance of experimental group that was pre-treated with zinc oxide-based nanofertilizer, pre-treated with copper-zinc-iron oxide-based nanofertilizer, and negative control.

Red bean seeds were pretreated using the same protocol as above, and sown in soil treated with nitrogen-phosphorus-potassium fertilizer (right since of FIG. 16) and untreated soil (left side of FIG. 16), and growth observed.

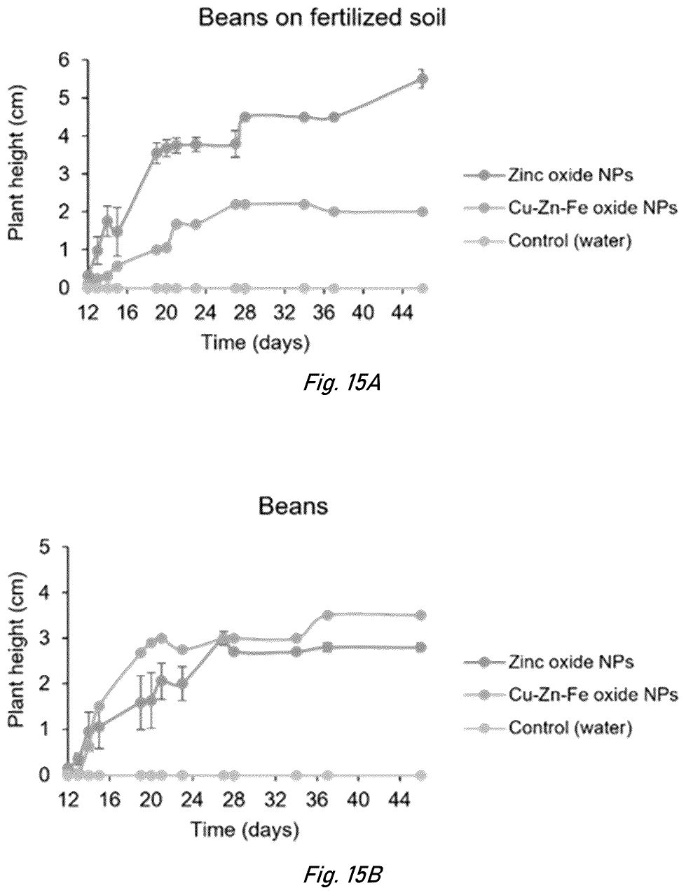

Plant height measurements between 12 and 45 days show nanofertilizer pre-treated specimens of red bean grew robustly in both fertilized (FIG. 15A) and unfertilized (FIG. 15B) soils. In both experimental samples, the negative control failed to germinate.

### Example 9. Field Trials

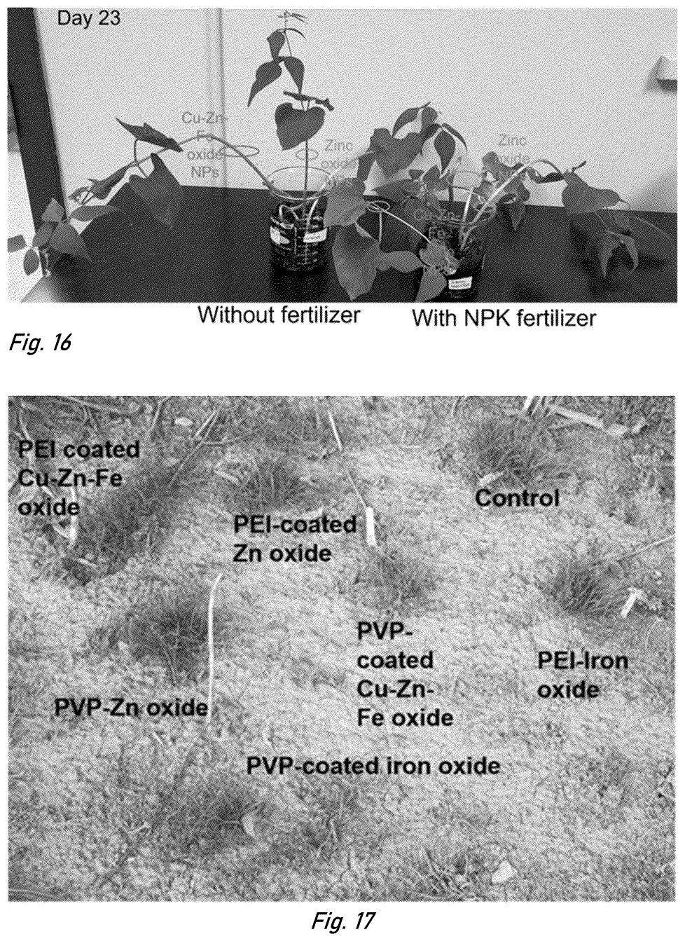

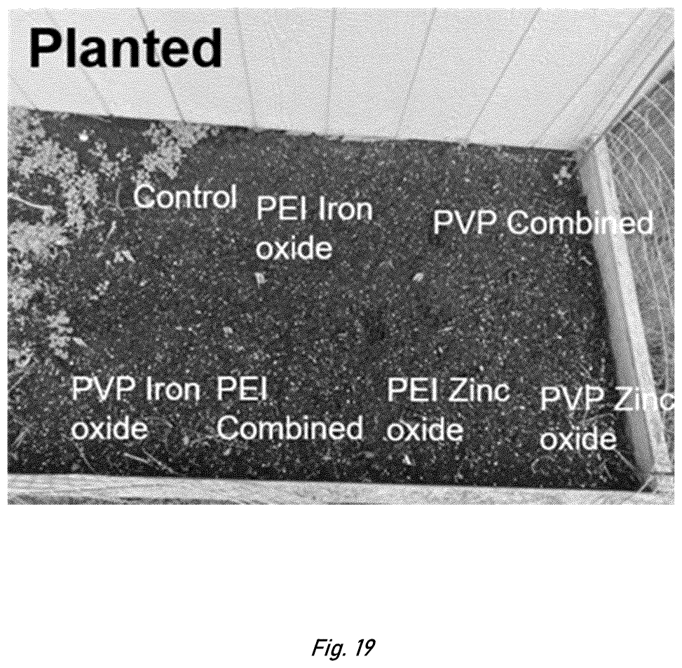

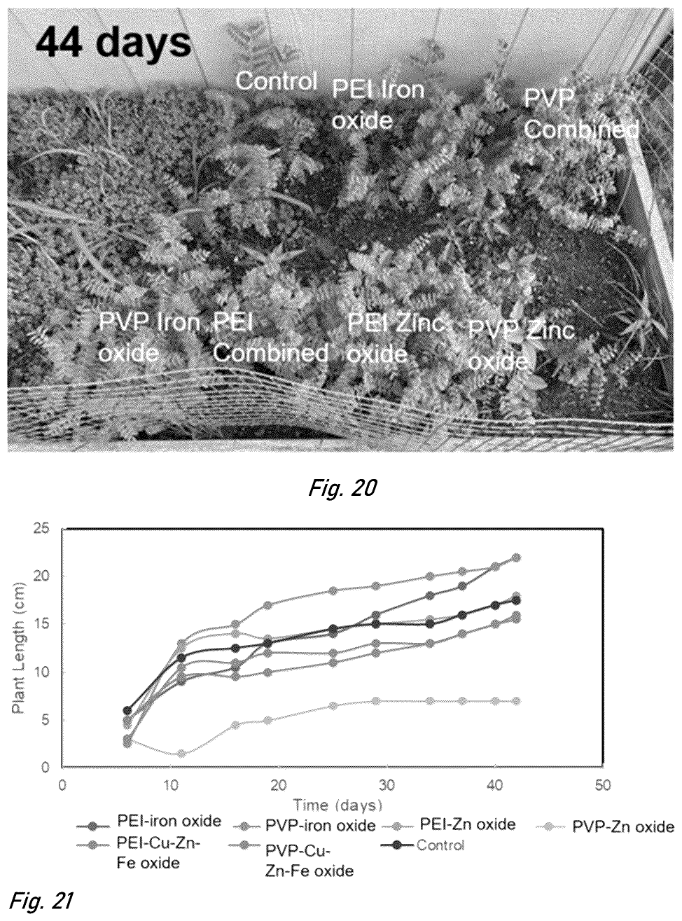

The zinc oxide-based and copper-zinc-iron oxide-based nanofertilizer compositions products were tested in the field using grass and garbanzo beans as trials. Two 3-inch plots were used for the field trial on grass (FIG. 17), while an 8-foot×4-foot raised bed plot was used for the trial on the garbanzo beans (FIGS. 19, 20). All the experimental test plots used for field trials were located in Xenia, Ohio. This is the first report of field trials of the nanofertilizer products.

The grass seeds and the garbanzo seeds were pre-soaked in the various tested nanofertilizer products—nanofertilizer comprising copper-zinc-iron oxide-based nanoparticles coated in PEI, nanofertilizer comprising zinc oxide-based nanoparticles coated in PEI, nanofertilizer comprising zinc oxide-based nanoparticles coated in PVP, nanofertilizer comprising copper-zinc-iron oxide-based nanoparticles coated in PVP overnight, nanofertilizer comprising iron oxide-based nanoparticles coated in PEI, and nanofertilizer comprising iron oxide-based nanoparticles coated in PVP—prior to planting them on the ground along with the control seeds that were untreated.

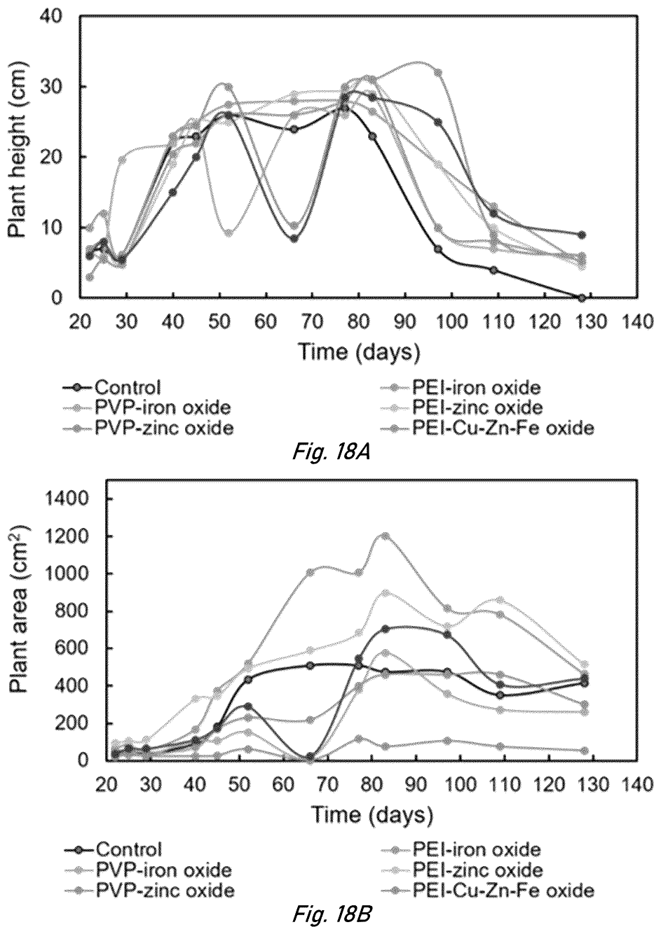

The height and area of the grass seeds were monitored via weekly measurements and imaging. The growth of the garbanzo plants was also measured weekly and imaged to understand the effect of the zinc oxide-based and Cu—Zn—Fe oxide-based nanofertilizers. FIG. 17 shows the growth and area plots of the grass seeds on the field while FIG. 20 shows the growth of the garbanzo beans. The seeds treated with PEI-zinc oxide nanofertilizers showed increased growth as compared to the control garbanzo seeds (FIG. 21). The nanofertilizer-treated grass seeds sprouted two days earlier than the control and also showed higher density and growth. The heights of all nanofertilizer-treated grass seeds were higher than the control grass. The PEI-coated zinc oxide nanofertilizers induced a 1.24 times increase in the area of the grass while the Cu—Zn—Fe oxide nanofertilizers induced a 1.05 times enhancement in area of the grass as compared to the control in the field trials (FIG. 18B).

### Example 10. Synthesis of Zinc Oxide-Based Nanofertilizer Compositions

Chemicals were purchased from Sigma Aldrich, VWR, TCI Chemicals, and Thermo Scientific and used as is without further purification: zinc (II) acetylacetonate (Zn(acac)₂, Thermo Scientific, 25% Zn), triethylene glycol (TREG, Thermo Scientific, 99%), poly(ethylenimine) solution (PEI, Sigma Aldrich, Mw: 60,000 kDa-50 wt % in water), polyvinylpyrrolidone (PVP, Sigma Aldrich, Mw: 10,000 kDa), and de-ionized water (DI, VWR).

Zinc oxide nanoparticles were synthesized via a new modified polyol route using a Schlenk line system. The reactions were conducted without any inert atmosphere. Different polymeric coatings of PVP/PEI ligand mixtures (i.e., 0.01 mmol PEI, 0.01 mmol PVP, 7:1 molar ratio of PVP:PEI, 12:1 PVP:PEI by mol, and 14:1 molar ratio of PVP:PEI) were used to form the new formulations of zinc oxide nanoparticles with different ligand coatings. The ligand mixture was dissolved in the solvent, triethylene glycol (TEG) (10 mL) by heating at 90° C. for 10 minutes. The zinc precursor, Zn(acac)₂ was then added to the reaction mixture and mixed for 30 minutes. The reaction was heated at 290° C. for 1 hour to form the zinc oxide nanoparticle product. The nanoparticles were washed in ethanol/water mixture via high-speed centrifugation (15,000 rpm, 15 minutes, room temperature) to remove any unreacted ligands. The zinc oxide nanoparticles were dissolved in water to achieve the desired concentrations of 0.0262 g/mL to 0.02705 g/mL for application in the plant growth studies.

### Example 11. Synthesis of Copper-Zinc-Iron Oxide-Based Nanofertilizer Compositions

Chemicals were purchased from Sigma Aldrich, VWR, TCI Chemicals, and Thermo Scientific and used as is without further purification: zinc (II) acetylacetonate (Zn(acac)₂, Thermo Scientific, 25% Zn), iron (III) 2,4-pentanedionate (Fe(acac)₃, TCI, 98%), copper (II) acetylacetonate (Cu(acac)₂, ACROS, 98%), triethylene glycol (TREG, Thermo Scientific, 99%), poly(ethylenimine) solution (PEI, Sigma Aldrich, Mw: 60,000 kDa-50 wt % in water), polyvinylpyrrolidone (PVP, Sigma Aldrich, Mw: 10,000 kDa), and de-ionized water (DI, VWR).

Cu—Zn—Fe oxide nanoparticles were synthesized by mixing of the ligand molecules, PEI (0.01 mmol) in 10 mL of the solvent, TEG for 30 minutes in a three-neck flask using a Schlenk line system. The reaction was conducted under normal atmospheric conditions under the chemical hood without any inert gas protection. The ligand solution was heated at 90° C. for 10 minutes for complete dissolution in the solvent. The metal precursors, Fe(acac)₃ (2 mmol), Zn(acac)₂ (0.25 mmol), and Cu(acac)₂ (0.25 mmol) were added to the reaction mixture and stirred for 30 minutes before heating the reactants at 290° C. for 1 hour to form the Cu—Zn—Fe nanoparticle product. The product is readily soluble in water and was washed with ethanol/water mixture via centrifugation (room temperature, 15,000 rpm, 15 minutes) to remove any unreacted organics. Several embodiments of nanoparticle formulations for the Cu—Zn—Fe system were prepared via this modified polyol approach with different biocompatible polymer coatings comprising various biocompatible PVP/PEI polymer mixtures (e.g., 7.2:1, 12:1, 14:1 molar ratio of PVP:PEI).

### Example 12. Scale-Up Synthesis

A ten-fold scaled-up production of the zinc oxide-based and Cu—Zn—Fe oxide-based nanofertilizer products was tested and compared to the laboratory-scale synthesis. The scaled-up synthesis was conducted using a Schlenk line system under the chemical hood. In a typical scale-up synthesis, the ligand (e.g., PEI or PVP) was dissolved in the solvent (TEG, 100 mL) by heating at 90° C. for 10 minutes. The respective metal precursors (i.e., Zn(acac)₂, 20 mmol for zinc oxide-based nanofertilizers and 2.5 mmol of Cu(acac)₂, 2.5 mmol of Zn(acac)₂, and 20 mmol of Fe(acac)₃ for the Cu—Zn—Fe oxide-based nanofertilizers) were added to the reaction, mixed for 10 minutes, and the reaction was heated at 290° C. for 1 hour to form the large-scale batch of the nanofertilizer products.

### Example 13. Dynamic Light Scattering Characterization

Zinc oxide-based and copper-zinc-iron oxide-based nanofertilizer samples were characterized on a NanoBrook® 90Plus (Brookhaven) dynamic light scatter (DLS) particle analyzer equipped with zeta potential capability to assess their hydrodynamic size and surface charge. Samples for the DLS were prepared by dissolving 100 μL of the respective nanofertilizer formulation in 2 mL of deionized (DI) water. Size and zeta potential measurements for each nanofertilizer sample were reported as an average of five consecutive runs at room temperature. Measurements were conducted using 3 mL disposable plastic cuvettes for both size and zeta potential analyses.

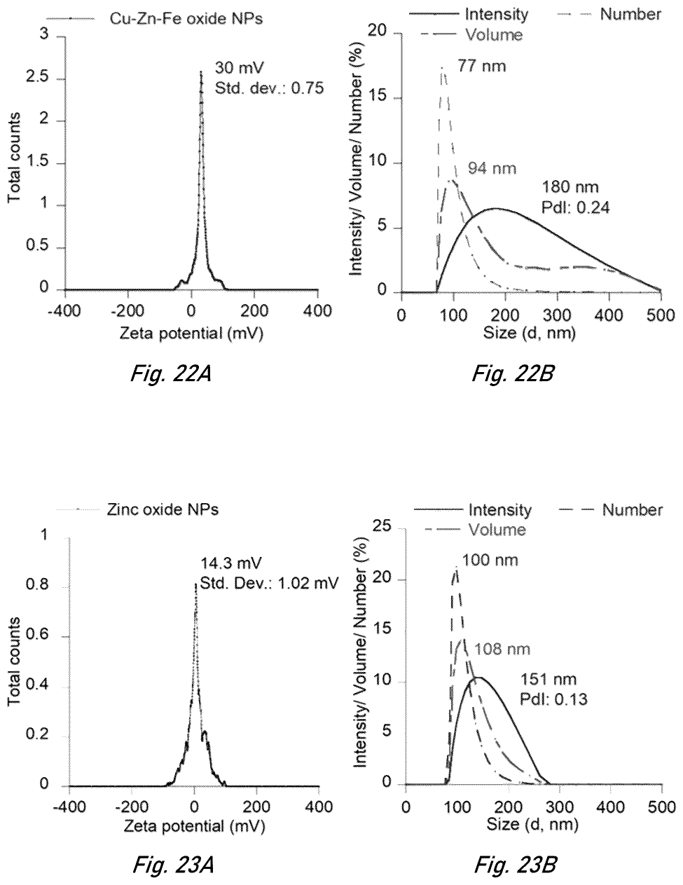

The copper-zinc-iron oxide-based composition is measured to be positively charged with a zeta potential of 30 mV owing to the presence of NH₂ surface functional groups in its outer coating (FIG. 22A). The high absolute value of the zeta potential indicates that the nanoparticles (NPs) are electrostatically stabilized. The hydrodynamic size of this nanofertilizer formulation is 77 nm from the number-based DLS size analyses (FIG. 22B). The polydispersity index (PdI, 0.24) of this sample is below 0.3 suggesting that the nanoparticles are mostly monodisperse.

In comparison, the zinc oxide-based nanofertilizers are larger with a number-based hydrodynamic size of 100 nm (PdI: 0.13) (FIG. 23B) and more monodisperse and are also positively charged. The nanofertilizer shows a zeta potential of 14 mV, suggesting a sterically stabilized surface (FIG. 23A).

### Example 14. X-Ray Diffraction

The crystal structures of the zinc oxide-based and copper-zinc-iron oxide-based nanofertilizers were characterized via powder x-ray diffraction (XRD) using a Rigaku SmartLab® x-ray diffractometer. The nanofertilizers were washed with ethanol and water using high-speed centrifugation at 13,000 rpm for 15 minutes under room temperature conditions (Sorvall Legend Micro 17, Fisher) to remove the unreacted ligands. The washed samples were left to dry overnight to prepare the well-dried powdered samples for the XRD measurements. XRD measurements for each sample were taken at 2θ angles of 10 degrees to 80 degrees.

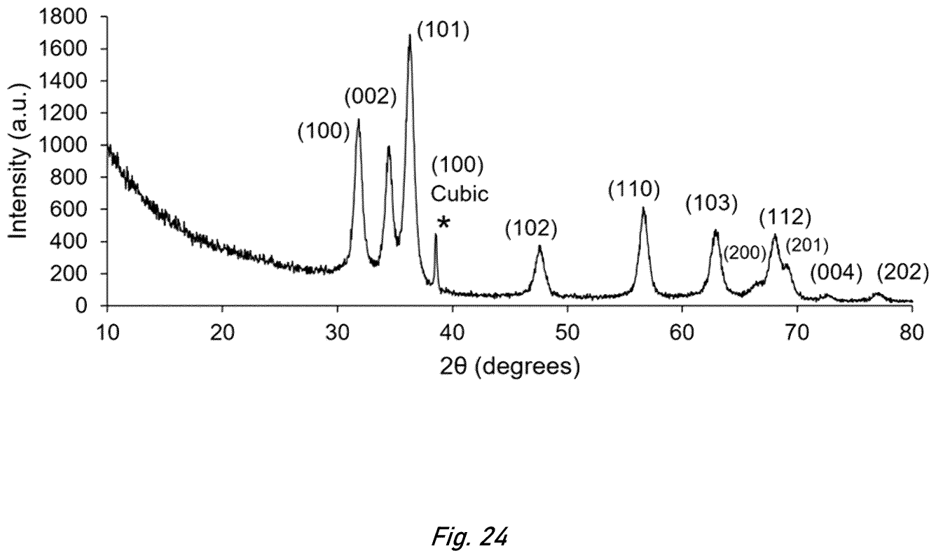

The XRD data shows that the crystal structure of the zinc oxide nanofertilizers is primarily wurtzite. Some cubic-phase zinc oxide nanoparticles are also present within the sample. The XRD peaks can be indexed to the (100), (002), (101), (102), (110), (103), (200), (112), (201), (004), and (202) crystal planes corresponding to 2θ angles of 32.0°, 34.5°, 36.3°, 47.6°, 56.6°, 63.0°, 67.0°, 68.2°, 69.2°, 73.0°, and 77.2° of the hexagonal wurtzite phase (space group P63mc, No. 186, 01-078-3322) of ZnO from the Inorganic Crystal Structure Database (ICSD) (165009) database. The peak at 38.6° correspond to the cubic ZnO phase (space group Pm-3m, No. 221, 01-080-4983) based on the ICSD database, indicating the presence of some cubic phase crystals in the nanofertilizer (FIG. 24).

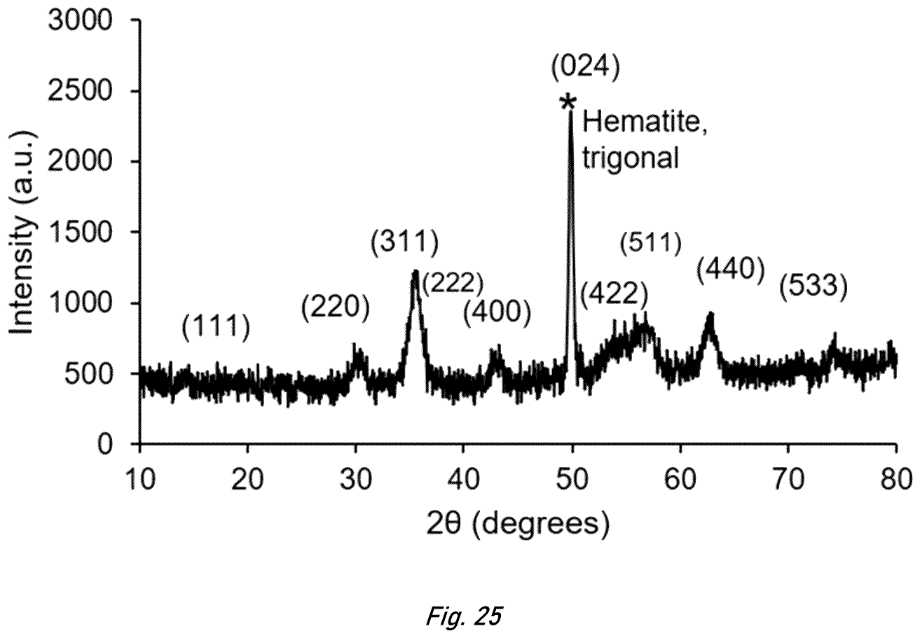

The nanofertilizer formulation with a core of multiple micronutrients, i.e., mixture of copper, zinc, and iron oxides, is primarily composed of the cubic phase of Cu₄Zn₆Fe₂O₄ (space group Fd-3m, No. 227, 01-077-0013) while some hematite nanoparticles in the trigonal phase (space group R-3c, No. 167, 01-080-5408) are also present within the crystal structure, as seen from the XRD analysis (FIG. 25). The XRD peaks corresponding to 2θ angles of 18.2°, 30.1°, 35.7°, 37.0°, 43.0°, 53.4°, 56.9°, 62.5°, and 73.9° closely match with the (111), (220), (311), (222), (400), (422), (511), (440), and (533) crystal planes of the cubic phase of Cu₄Zn₆Fe₂O₄, based on the IC SD database. The presence of the trigonal phase of hematite within the nanofertilizer crystal structure is seen from the prominent peak at 49.9° corresponding to the (024) plane of hematite.

### Example 15. Transmission Electron Microscopy

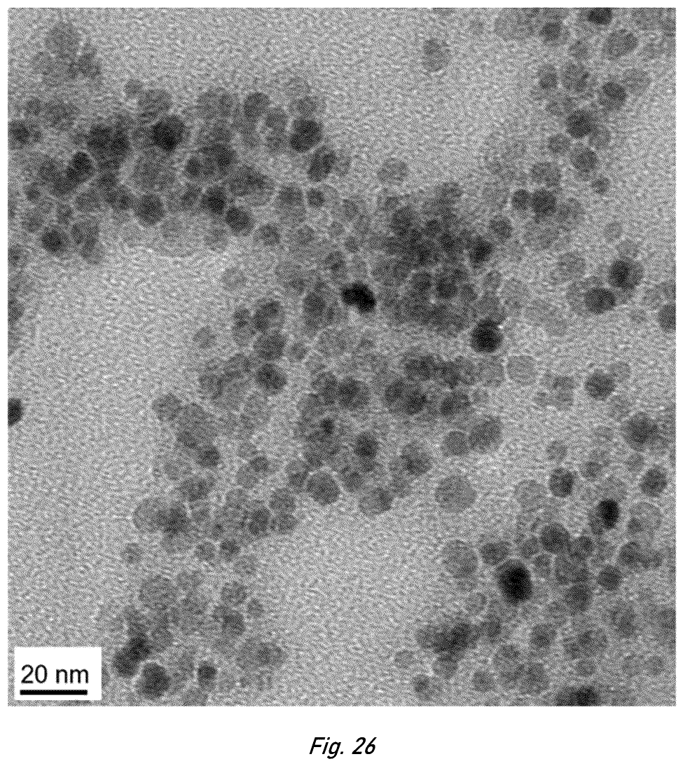

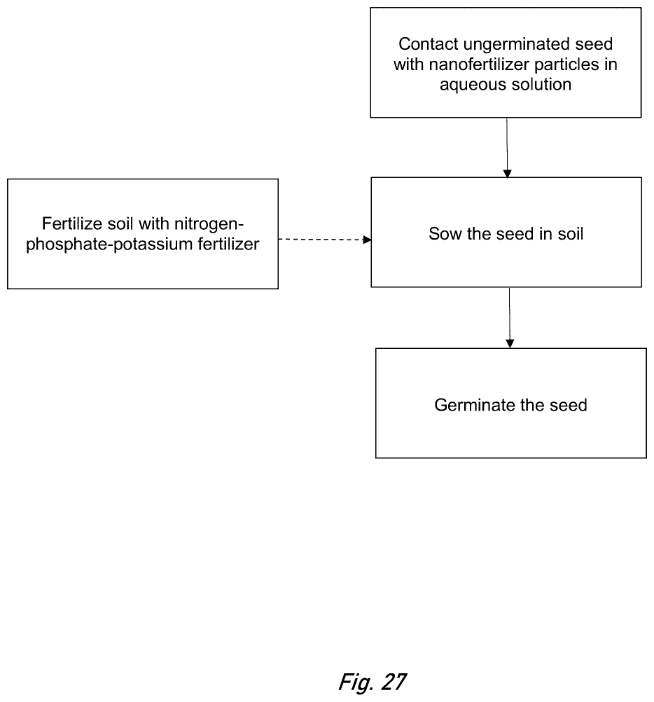

The physical size and morphology of the nanofertilizer particles were investigated using the Hitachi H-7600 transmission electron microscope (TEM). TEM samples were prepared by adding 100 μL of the aqueous nanofertilizer sample that have been well dispersed via sonication for 15 minutes (Branson 1800, room temperature) on carbon-coated Cu grids (300 mesh). FIG. 26 shows the TEM image of the multiple micronutrient-based nanofertilizers. These nanoparticles are spherical and are 8 nm in size.

### REFERENCES

The contents of each of the following publications are incorporated by reference herein in their entireties:
Palchoudhury, Soubantika, et al. “A Novel Experimental Approach to Understand the Transport of Nanodrugs.” Materials 16.15 (2023): 5485.
Boutchuen, Armel, et al. “Increased plant growth with hematite nanoparticle fertilizer drop and determining nanoparticle uptake in plants using multimodal approach.” Journal of Nanomaterials 2019 (2019): 1-11.
Boutchuen, Armel, et al. “Understanding nanoparticle flow with a new in vitro experimental and computational approach using hydrogel channels.” Beilstein Journal of Nanotechnology 11.1 (2020): 296-309.

1. A nanofertilizer composition comprising a particle, the particle comprising
a crystalline core comprising
zinc oxide, and
a coating covering a surface area of the crystalline core, the coating comprising a biocompatible polymer.

2. The nanofertilizer composition of claim 1, wherein the crystalline core further comprises an oxide of copper and oxide of iron.

3. The nanofertilizer composition of claim 2, wherein the crystalline core comprises a mixture of cubic-phase Cu₄Zn₆Fe₂O₄ and trigonal hematite.

4. The nanofertilizer composition of claim 2, wherein the relative molar amounts in the crystal of zinc, copper, and iron is about 1:1:8.

5. The nanofertilizer composition of claim 1, wherein the coating is selected from: polyethylenimine, polyvinylpyrrolidone, and a mixture of polyethylenimine and polyvinylpyrrolidone.

6. The nanofertilizer composition of claim 1, wherein the zinc oxide of the crystalline core comprises a crystal structure selected from: hexagonal, cubic, and a mixture of hexagonal and cubic.

7. The nanofertilizer composition of claim 1, wherein the particle has a hydrodynamic diameter of about 50 nm to about 175 nm.

8. The nanofertilizer composition of claim 1, wherein the particle has a diameter of about 5 nm to about 15 nm.

9. A fertilizer composition comprising an aqueous solution comprising the nanofertilizer composition of claim 1.

10. A nanofertilizer particle comprising
a crystalline core comprising a mixture of oxide of zinc, oxide of iron, and oxide of copper, and
a coating covering a surface area of the crystalline core, the coating comprising a biocompatible polymer comprising polyethylenimine, polyvinylpyrrolidone, or a mixture of polyethylenimine and polyvinylpyrrolidone.

11. A method of enhancing plant growth, the method comprising
contacting a germination-capable plant tissue with an aqueous fertilizer for a period of time prior to germination of the germination-capable plant tissue,
wherein the aqueous fertilizer comprises a solution comprising a nanofertilizer composition comprising a nanoparticle, the nanoparticle comprising
a crystalline core comprising
zinc oxide, and
a coating covering a surface area of the crystalline core, the coating comprising a biocompatible polymer.

12. The method of claim 11, wherein the germination-capable plant tissue is a seed of maize.

13. The method of claim 11, wherein the germination-capable plant tissue is a seed of a legume.

14. The method of claim 13, wherein the legume is selected from: chickpea, green bean, green gram, and pea.

15. The method of claim 11, wherein the volume of the aqueous fertilizer contacted to the germination-capable plant tissue is about 0.01 mL to 0.1 mL.

16. The method of claim 15, wherein the mass of nanofertilizer composition in the volume of aqueous fertilizer is about 0.1 mg to 3 mg.

17. The method of claim 11, wherein the concentration of nanofertilizer composition in the solution is 0.01 g/mL to 0.05 g/mL.

18. The method of claim 11, wherein the crystalline core further comprises an oxide of iron and copper.

19. The method of claim 11, wherein the coating is selected from: polyethylenimine, polyvinylpyrrolidone, and a mixture of polyethylenimine and polyvinylpyrrolidone.

20. The method of claim 11, wherein the nanoparticle has a hydrodynamic diameter of from about 50 nm to about 175 nm.

21. The method of claim 11, wherein the nanoparticle has a diameter of about 5 nm to about 15 nm.

22. The method of claim 11, further comprising, after the step of contacting a germination-capable plant tissue with the aqueous fertilizer for a period of time prior to germination of the germination-capable plant tissue, sowing the germination-capable plant tissue in a soil that, optionally, is fertilized with nitrate-phosphate-potassium fertilizer.
